(19) United States
(12) Patent Application Publication
(10) Pub. No.: US 2008/0080869 A1
(43) Pub. Date: Apr. 3, 2008

(54) Optical Signal Processing Device

(76) Inventors: Arnan Mitchell, Melbourne (AU); Bui Anh Lam, Melbourne (AU); Sana Ahmed Mansoori, Melbourne (AU)

Correspondence Address: WEINGARTEN, SCHURGIN, GAGNEBIN & LEBOVICI LLP, TEN POST OFFICE SQUARE, BOSTON, MA, 02109, US

(21) Appl. No.: 11/664,769

(22) PCT Filed: Oct. 6, 2005
(86) PCT No.: PCT/AU05/01539

§ 371 Date: Aug. 13, 2007

(30) Foreign Application Priority Data
Oct. 6, 2004 (AU) 2004905778

(51) Int. Cl. G02B 6/27; G02B 27/28; H04B 10/12; H04B 10/20; H04J 14/02; H04B 10/18; G02B 5/28

(52) U.S. Cl. 398/147

(57) ABSTRACT

The present invention provides an optical processing device (10). The device comprises an optical guiding arrangement having an input (12) and an output (14) and at least two arms (16, 18) between the input (12) and output (14). The at least two arms (16, 18) are coupled so that light guided through one arm will interfere with light guided through the or each other arm. The device (10) also comprises an optical modulator (22) that is arranged to impart a modulation on at least some of the light guided through at least one arm. In addition, the device (10) comprises a polarisation rotator (20) for rotating the polarisation of at least a portion of the guided light so as to control a modulation gain coefficient of the device.

### FIELD OF THE INVENTION

The present invention broadly relates to an optical signal processing device.

### BACKGROUND OF THE INVENTION

Modulator based photonic filters are frequently used for processing photonic signals. Such filters often include a range of wavelength specific time delay lines which result in a predetermined filter transfer function. Using an incoherent approach and modulators having positive modulation gain coefficients, low-pass filters having positive impulse response coefficients have been designed.

Other types of filter, such as pass-band filters, are more difficult to design as they have an impulse response function that also has negative parts. For example, the impulse response function of a pass-band filter having a “square” transmission function is a sinc-type function having positive and negative parts which may be approximated by a sequence of negative and positive impulse response coefficients.

In general, even modulator-based photonic processing devices that have a function which is simpler than that of such a pass-band filter are often technologically complex and bulky and consequently there is a need for technological advancement.

### SUMMARY OF THE INVENTION

The present invention provides in a first aspect an optical processing device comprising:

an optical light guiding arrangement having an input and an output and at least two arms between the input and the output, the at least two arms being coupled so that light guided through one arm will interfere with light guided through the or each other arm,
an optical modulator being arranged to impart a modulation on at least some of the light guided through at least one arm and
a polarisation rotator for rotating the polarisation of at least a portion of the guided light so as to control a modulation gain coefficient of the device.

The polarisation rotator may be arranged for at least partial inversion of the polarisation which would enable signal processing with negative modulation gain coefficients. In this case the polarisation rotator typically is arranged to rotate the polarisation by any angle in the range π(2n+1)/2 to π(n+1) (n: integer).

The polarisation rotator may also be suitable for rotating the polarisation by an other angle, and typically is also suitable for rotating the polarisation by an angle by in the range of m*π to π(2m+1)/2 (m: integer) which does not invert the polarisation of the guided light. In this case it is possible to design the photonic processing device having positive and negative modulation gain coefficients. For example, optical processing device may be arranged so that in use the optical processing device has a positive modulation coefficient for at least one wavelength of guided light and a negative modulation coefficient for at least one other wavelength of guided light.

For example, a filter may be designed having an impulse response function with negative coefficients for some wavelength and positive coefficients for other wavelengths, which would correspond to the negative and positive modulation gain coefficients.

The modulator may be an optical phase modulator arranged to impart a phase modulation. Alternatively, the modulator is an optical intensity modulator arranged to impart in intensity modulation.

In a first specific embodiment of the invention the modulator and the polarisation rotator are incorporated in respective arms of the light guiding arrangement. In this embodiment the optical modulator is a phase modulator arranged to impart a phase modulation as a function of an applied electrical signal V(t) and/or as a function of an applied bias voltage V_{b}. Typically the polarisation rotation effected by the polarisation rotator is dependent on a power applied to the rotation polarisator.

The device typically is arranged so that output power Pₒᵤₜ is proportional to ½(1+cos(Aπ)cos(2V(t)+V_{b})) where A is proportional to a power applied to the polarisation rotator.

In a second embodiment of the invention the device comprises at least one intensity modulator. In a specific embodiment the device comprises at least two intensity modulators and is arranged so that light is guided through the polarisation rotator and respective portions of the light are guided through respective intensity modulators. In this embodiment each intensity modulator is associated with a respective arm of the device. The polarisation rotator may be positioned so that in use the light passes through the polarisation rotator before being split into the at least two arms of the device. In this case the optical light guiding arrangement typically comprises a polarisation splitter that is arranged to split at least some of the guided light into the respective portions for guiding through the respective modulators. Further, the output typically comprises, or is connected to a polarisation combiner.

In a third specific embodiment of the invention the device comprises at least two modulators for modulating respective portions of the light guided through respective arms of the device. Further, the device may comprise at least two polarisation rotators for rotation the polarisation of respective portions of the light guided through respective arms of the device. In this embodiment the input typically comprises, or is connected to, an adiabatic Y-splitter and the output typically comprises, or is connected to, a directional coupler such as a polarisation directional coupler.

In a variation of this embodiment one modulator and/or one polarisation rotator is associated with both arms of the device.

The polarisation rotator typically is arranged so that the rotation of the polarisation is possible in a wavelength specific manner. For example, the device may be arranged so that the simultaneous (or sequential) modulation of different wavelength ranges of a photonic signal is possible and each wavelength range may be modulated with a specific modulation index. The device may therefore allow processing of individual channels of a wavelength division multiplexed (WDM) photonic signal without the need to separate the channels. For example, processing of the WDM photonic signal may include to weight individual channels using both positive and negative impulse response coefficients.

In a specific example the polarisation rotator may be an acoustic-optic polarisation rotator such as a device in which a surface acoustic wave generates a refractive index variation that functions like a grating and therefore has wavelength specific properties. In some materials, such as LiNbO₃, the velocities for TE and TM polarisation modes are different which may be utilised to rotate the polarisation of guided light. Alternatively, the polarisation rotator may for example be an electro-optic polarisation rotator.

The modulator typically has a terminal for receiving an ac electrical signal and typically comprises an electro-optic material arranged so that light is guided through or adjacent the electro-optic material and in use the ac electrical signal generates a phase modulation of the light guided through at least a portion of the light guiding arrangement. The terminal for receiving the ac electrical signal typically comprises at least one rf cavity.

The present invention provides in a second aspect a method of processing a photonic signal, comprising the steps of:

guiding light through at least two arms of an optical light guiding arrangement,

modulating at least some of the guided light,

rotating the polarisation of at least a portion of the guided light to determine a modulation coefficient of the modulation and thereafter

interfering the light guided through the or each arm.

The step of rotating the polarisation typically is performed in a wavelength specific manner so that for at least one wavelength of the guided light a positive modulation is effected and for at least one other wavelength of the guided light a negative modulation coefficient is effected.

The invention will be more fully understood from the following description of specific embodiments of the invention. The description is provided with reference to the accompanying drawings.

### BRIEF DESCRIPTION OF THE DRAWINGS

FIG. 1 shows a photonic processing device according to a first specific embodiment of the present invention,

FIG. 2 shows (a) power versus drive voltage plots and (b) the derivative of the plots shown in FIG. 2 (a) for the device according to the first specific embodiment,

FIG. 3 shows a photonic processing device according to a second specific embodiment of the present invention,

FIG. 4 shows a photonic processing device according to a third specific embodiment of the present invention,

FIG. 5 shows a diagram illustrating the operation of a directional coupler,

FIG. 6 shows a balanced bridge modulator,

FIG. 7 shows power versus coupling length plots for a polarisation splitter, and

FIG. 8 shows power versus coupling length plots for a polarisation diverse 3 dB splitter.

### SPECIFIC EMBODIMENTS OF THE PRESENT INVENTION

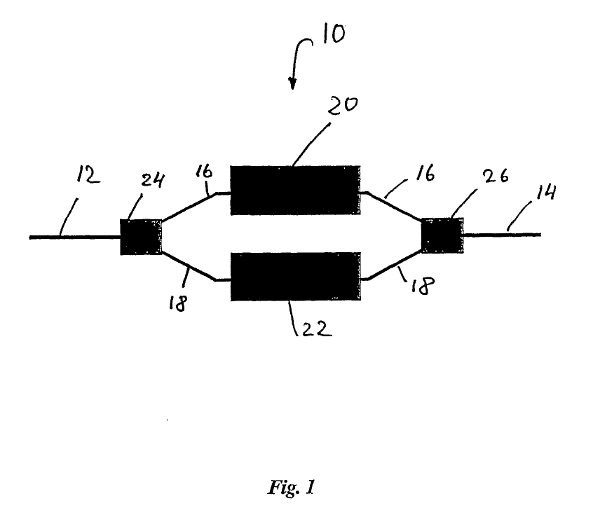

Referring initially to FIG. 1 a photonic signal-processing device and a method of processing a photonic signal according to the first specific embodiment of the invention is now described. FIG. 1 shows the photonic signal processing device 10 which comprises an input 12 and an output 14 connected by two arms, 16 and 18 of the device 10. The arm 16 comprises a polarisation rotator 20 which in this case is a acousto-optic polarisation rotator. The arm 18 comprises a phase modulator 22 and two adiabatic Y splitters 24 and 26 connect the arm 16 and 18 of the device 10 with the input 12 and the output 14 respectively.

The modulator 22 comprises a terminal for receiving an rf electrical signal. The modulator 22 also comprises an electro-optic active material which changes its refractive index in response to the electrical field associated with an applied rf signal. In this embodiment, light is guided through the electro-optic active material and the modulation of the refractive index effects a phase modulation of the light guided through arm 18. In a variation of this embodiment light is guided directly adjacent to the electro-optic active material which also results in a phase modulation of the guided light.

In use polarised light is received by the input 12. The adiabatic Y-splitter 24 equally splits both polarisations between the two arms 16 and 18. In this embodiment the power in the lower arm is phase modulated by modulator 22. In a variation of this embodiment the power in either or both arms can be phase modulated. The power of the light guided in the arm 16 is polarisation rotated by the polarisation rotator 20 which in this embodiment is a wavelength selective polarisation rotator (WSPR). In this example the WSPR is an acousto-optic polarisation rotator (AOPR) but in a variation of this embodiment the WSPR may also be an electro-optic polarisation rotator (EOPR).

If a suitable power is applied to the WSPR 20, then no polarisation rotation occurs and the device 10 behaves as a Mach Zehnder modulator. If power is applied to the WSPR 20, then polarisation rotation will occur. A rotation from TE to TM results in the light portions guided through the two arms becoming orthogonal. There is thus no constructive interference at the output and the modulator will not modulate, providing instead a constant 3 dB attenuation to the input light. If more power is applied to the WSPR 20, the power in the arm 16 will convert from TE to TM and back to TE again. During this process it will accumulate a π phase shift. Interference will occur at the output, but the response will be shifted by π. If the device is biased at quadrature, this π phase shift will result in conversion from a positive slope to a negative slope for the gain of the modulation. In this way, negative coefficients can be realised.

Mathematically, the output optical power (I) as a function of applied voltage (V) can be expressed as:

I=½(1+cos(Aπ)cos(2V+V_{b})) eq.1

Where A is proportional to the power applied to the WSPR and V_{b} is a bias voltage. The gain of the photonic link will be proportional to the derivative of this expression. This can be expressed:

G∝cos(Aπ)sin(2V+V_{b})) eq.2

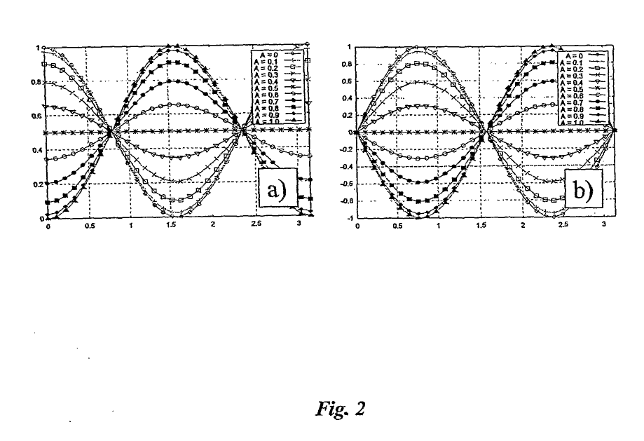

FIG. 2 (a) shows optical power versus drive voltage plots illustrating Equation (1) for several values of A. FIG. 2(b) shows the derivative of the plots shown in FIG. 2(a) illustrating the gain of Equation (2). It is evident that if the modulator is biased at π/4, then the optical power at the output will not change, but the gain will vary from +1 to −1 as the drive power to the WSPR is varied.

Each optical wavelength may be set with a different value of A in order to realise a WDM signal processing system.

As indicated above, in this embodiment the WSPR is an acousto-optic polarisation rotator 20 which comprises a piezoelectric material, such as LiNbO₃, and a strip of reduced acoustic velocity material that forms a waveguide for light. The LiNbO₃ material is coupled to integrated transducer electrodes which receive an rf electrical signal which generate, due to the piezoelectric properties of the LiNbO₃ material, surface acoustic waves. The polarisation rotator 20 is arranged so that the surface acoustic waves are directed along the waveguiding strip. Along the strip the surface acoustic waves therefore form a periodic refractive index variation which effectively functions as a grating assisted polarisation coupler and therefore is wavelength specific. The device is arranged so that the propagation velocities of the TM and TE polarisation modes are different which is utilised to rotate the polarisation of guided light by any angle.

A range of different rf electrical signals may be applied to the transducer electrodes, either sequentially or in parallel, and it is therefore possible to either simultaneously or sequentially rotate the phase of the guided light in a wavelength specific manner. Further details of the acousto-optic polarisation rotator which is used in this embodiment as WSPR are disclosed in H. Mendis, A. Mitchell, I. Belski, M. Austin, O. A. Peverini, Journal of Applied Physics B 73, 1-5 (2001).

As indicated above, the WSPR The alternative ESPR is disclosed in R. Alferness, IEEE Journal of Quantum Electronics, Vol. QE-17, No. 6, pp. 965-969 (1981.

For example a pass-band filter has a sinc-type impulse response function having positive and negative regions. This function may be approximated by a sequence of positive and negative coefficients. By operating the device 10 in a predetermined manner, it is possible to rotate the polarisation of guided light in a manner so that a predetermined impulse response having positive and negative coefficients is effected and therefore it is possible to design a filter having a pass-band transmission function. It will be appreciated that any other type of filter may also be realised, such as low pass and high pass filters or multiple pass-band filters. For example, the device may be used for processing wavelength division multiplex (WDM) optical signals. By rotating the polarisation of light associated with specific channels and by applying an rf signal to the electrode of predetermined band width and intensity distribution within the bandwidth, it is possible to define the modulation depth of each channel individually. Further, it is possible to separately weight multiple channels, either simultaneously or sequentially, without the need to separate the channels. For example, the device 10 may be used as a transversal filter or, for example, for sign correlation, channel equalisation and signal transformation.

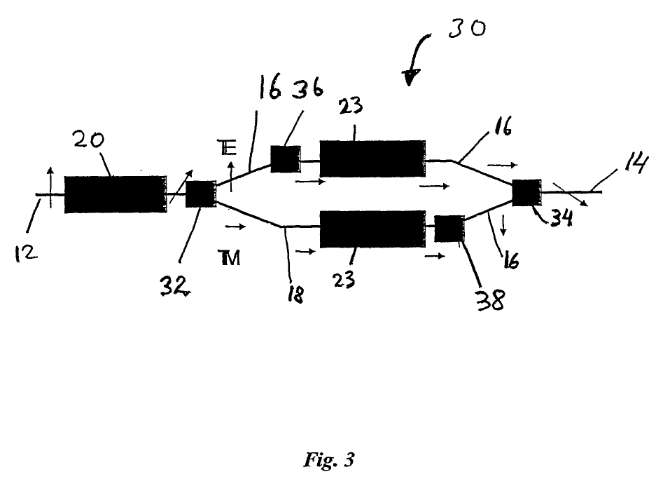

FIG. 3 shows a device according to a second specific embodiment. The device 30 comprises two intensity modulators 23 associated with respective arms 16 and 18. In this embodiment the WSPR 20 is positioned at the input 12 of the device 30 and before a polarisation splitter. At the output 14 of device 30 light is guided from both arms 16 and 18 into a polarisation combiner 34. The device further comprises two polarisation rotators 36 and 38. The WSPR 20 rotates the polarisation of received light such that a proportion is in the TE state and a proportion is in the TM state. These two polarisations are then incident on the polarisation splitter 32 and the polarisations are split into separate arms 16 and 18.

If the electro-optical material of the intensity modulators 23 is LiNbO₃, only one axis will have a strong electro-optic coefficient and thus only one polarisation can be modulated efficiently. Hence to ensure both polarisations are modulated efficiently, one polarisation is rotated prior to modulation. The light guided through the two arms the 16 and 18 is then modulated by identical modulators driven with identical signals, but biased at opposing quadratures. Biasing in this manner ensures one modulator has a positive gain, while the other has a negative gain.

After intensity modulation, the polarisation of the signal guided through arm 18 is rotated to ensure that the signals guided through arms 16 and 18 are orthogonal at the output and will thus combine incoherently. This combination is achieved through polarisation combiner 34.

With no power applied to the WSPR 20, no polarisation rotation occurs at the input and thus all of the power is transferred to the upper modulator 20 and a modulation coefficient (gain) of +1 is achieved. If sufficient power is applied to the WSPR 20 to rotate the input polarisation from TE to TM all of the power will be transferred to the lower modulator and the modulation (gain) of −1 is achieved. If some intermediate polarisation state is achieved then a weighted sum of positive and negative modulations will be achieved. If for example the polarisation is rotated to exactly ½ TE and ½ TM, then no modulation will result at the output.

An advantage of this embodiment is that only half the power is required at the WSPR 20 to convert the coefficient from +1 to −1. A disadvantage is that the RF power is split between the two modulators and this will reduce efficiency.

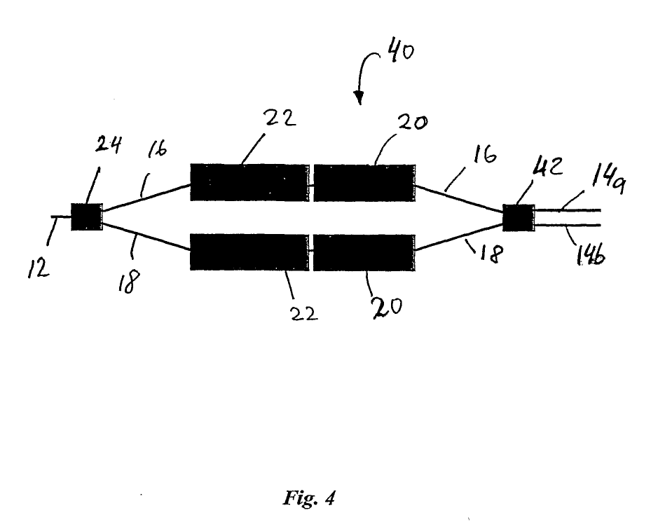

FIG. 4 shows a device according to a third specific embodiment. The device 40 comprises two phase modulators 22 associated with respective arms 16 and 18. In this embodiment two WSPR's 20 are positioned in sequence with respective modulators 22 on respective arms 16 and 18. The device 40 comprises an adiabatic Y-split 24 which splits light from input 12 into the arms 16 and 18. A polarisation diverse 3 dB splitter 42 is positioned between the arms 16 and 18 and outputs 14a and 14b.

To further illustrate the operation of the device 40 it is useful to consider the operation of directional couplers, balanced bridge modulators and polarisation splitters which will be described in section “Detailed description of directional couplers, balanced bridge modulators and polarisation splitters used in specific embodiments of the present invention”.

The device 40 is related to a balanced bridge modulator in that polarised light is introduced at the input. The light is split adiabatically by adiabatic Y-split 24 into two arms 16 and 18 and is phase modulated by modulators 22 with complimentary signals in a push-pull configuration. In this embodiment, the polarisation of the two optical signals are then both rotated by identical WSPR devices 20. The polarisation rotation in each arm is identical. The two signals are then incident on the polarisation divers 3 dB splitter 42. This component 42 is a variant of a polarisation splitter directional coupler that implements inverted 3dB couplers for TE and TM polarisations which is described in section “Directional couplers, balanced bridge modulators and polarisation splitters”.

If the polarisation is not rotated, the device operates as a balanced bridge Mach-Zehnder modulator. In this example the modulation has a positive modulation coefficient for arm 16 and a negative coefficient for arm 18. If the polarisation is converted completely from TE to TM then the device 40 will also behave as a balanced bride modulator, but with a negative coefficient on arm 16 and a positive coefficient on arm 18. If the polarisation is only partially converted, then the TE and TM components will be modulated with opposing coefficients and these will cancel one and other. In this way continuous adjustment of the modulation coefficient from +1 to −1 is achieved.

In a variation of this embodiment the device 40 comprises one modulator for both arms 16 and 18 and has only one rf electrode positioned so that light guided through arms 16 and 18 will be modulated. This variation has the advantage of a more efficient use of the available rf power. It also only requires conversion from TE to TM to change the coefficient from +1 to −1 and thus makes efficient use of the acousto-optic power. Since the two WSPR's 20 are identical, they could both be implemented using only a single acoustic waveguide and transducer set.

The specific embodiments shown in FIGS. 1, 3 and 4 have in common that it is possible to individually process multiple channels of an applied WDM signal. By rotating the polarisation of light associated with specific channels and by applying an rf signal to the modulator(s) of predetermined band width and intensity distribution within the bandwidth, it is possible to define the modulation depth of each channel and therefore process each channel individually. The modulation with negative and positive modulation coefficients allows the design of a processing device having an impulse response function with negative and positive coefficients.

The devices 10, 30 and 40 shown in FIGS. 1, 3 and 4 may be integrated devices comprising planar waveguiding structures. Alternatively or additionally, the devices may comprise optical fibres.

Although the invention has been described with reference to particular examples, it will be appreciated by those skilled in the art that the invention may be embodied in many other forms. For example, the device may comprise any number of arms. The device may also comprise any number and type of modulation devices and polarisation rotators. For example, the modulation device may not be arranged to receive an RF signal but may be arranged to receive any ac electrical signal.

The reference that is being made to the prior art citation is not an admission that this prior art citation forms part of the common general knowledge in Australia or in any other country.

### Detailed description of directional couplers, balanced bridge modulators and polarisation splitters used in specific embodiments of the present invention

### Directional Couplers

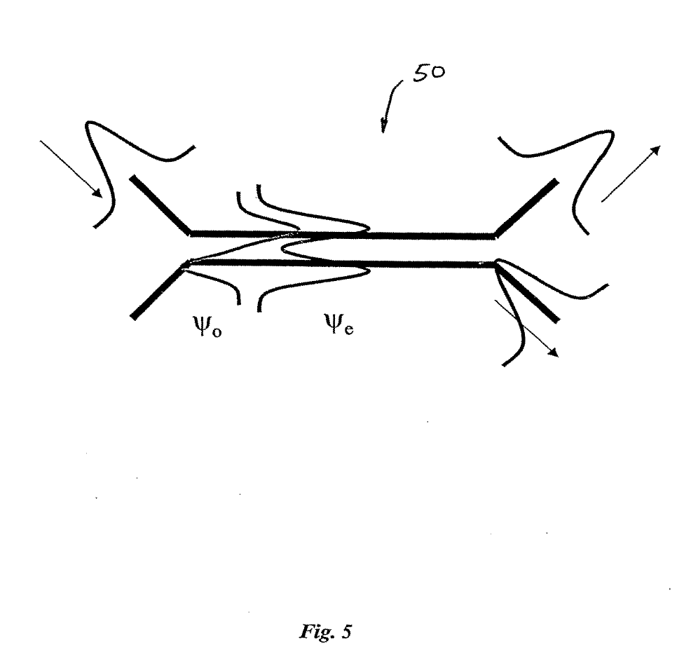

FIG. 5 shows a diagram illustrating the operation of a directional coupler 50. In this example the directional coupler 50 comprises a pair of closely spaced waveguides that couple. This waveguide pair supports two ‘supermodes’ as shown in FIG. 5. An excitation from one of the optical inputs will excite equal amounts of the two supermodes. If it is the upper waveguide the amplitudes excited will be equal and positive, if it is the lower waveguide the amplitudes will be equal and opposite. The two supermodes travel through the directional coupler 50 with different propagation constants and thus a phase difference is accumulated between the two modes along the length of the device. At the output, the two modes are decomposed again into the modes of the output waveguides. The field amplitude emerging from the two waveguides is thus:

Aₒᵤₜ₁=Aᵢₙe^{jφ/2}cos(φ/2) eq. 3

Aₒᵤₜ₂=jAᵢₙe^{jφ/2}sin(φ/2) eq. 4

### Where Aᵢₙ is the amplitude of the input field (complex) and φ is the accumulated phase between the even and odd supermodes.

The output power is thus:

Iₒᵤₜ₁=Iᵢₙcos²(φ/2) eq. 5

Iₒᵤₜ₂=Iᵢₙsin²(φ/2) eq. 6

The accumulated phase φ is proportional to the length of the coupling region. The coupling length L_{c} can be defined as

φ=πL/L_{c} eq. 7

The coupling length is primarily determined by the waveguide spacing within the coupling region. The waveguide parameters (such as waveguide width, diffusion length etc.) will also impact the coupling length. To make a directional coupler with a 3dB power split

L_{3dB}=L_{c}/2 eq. 8

### Balanced Bridge Modulator

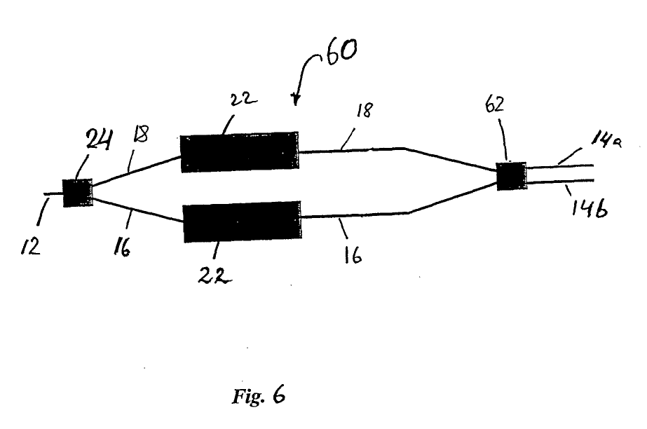

FIG. 6 shows an example of a balanced bridge modulator 60. A polarised optical carrier is received by input 12. This carrier is split equally between two paths using adiabatic Y-splitter 24. The two arms 16 and 18 of the modulator are electro-optically phase modulated by modulators 22 with signals of opposite polarity. This complimentary phase modulation is called push-pull operation and can be achieved with a single electrode and improves the efficiency of modulation. The phase-modulated carriers are then transferred to the output of the device where they are coherently combined in a 3dB directional coupler 62.

If it is assumed that equal and opposite phase shifts are introduced in each arm then we will have

Aᵢₙ₁=1/√2Aᵢₙe^{jθ} eq. 9

Aᵢₙ₂=1/√2Aᵢₙe^{-jθ} eq. 10

At the outputs 14a and 14b of the directional coupler 62, the signals are superimposed coherently, thus:

Aₒᵤₜ₁=Aᵢₙ₁e^{jφ/2}cos(φ/2)+jAᵢₙ₂e^{jφ/2}sin(φ/2) eq. 11

Aₒᵤₜ₁=1/√2Aᵢₙ(e^{jθ}e^{jφ/2}cos(φ/2)+je^{-jθ}e^{jφ/}22)) eq. 12

Thus, the power is:

Iₒᵤₜ₁=½ Iᵢₙ [1−sin(2θ)sin(φ) ] eq.13

Or Iₒᵤₜ₁= 1/2 Iᵢₙ [1−sin(2θ)sin(πL/Lc)] eq. 14

### Thus, if L=Lc/2, (the case for a balanced bridge modulator)

Iₒᵤₜ₁=½Iᵢₙ [1−sin(2θ)] eq. 15

Indicating the device 60 is naturally biased at quadrature. Similarly

Iₒᵤₜ₂=½Iᵢₙ (1+sin(2θ)sin(φ)) eq. 16

### If

L=Lc/2, we have Iₒᵤₜ₂=½Iᵢₙ (1+sin(2θ)) eq. 17

This again indicates that the device 60 is naturally biased at quadrature, but with the opposite gain slope. The two outputs are thus the compliment of one and other and this is why the modulator is termed a balanced bridge device.

### Polarisation Splitter

Having described how a directional coupler works, an integrated optic polarisation splitter is now described. For example, LiNbO₃ is a highly birefringent material and thus the waveguiding characteristics can be quite different for the two polarisations. In particular, it is possible to achieve a relatively strongly guiding, well isolated mode for the TE polarisation and a weakly guided, easily coupled waveguide for the TM polarisation.

It is thus possible to obtain different coupling lengths for the two polarisations in the same directional coupler over the same length and a polarisation splitter can be realised where

L_{cTE}=2L_{cTM} eq. 18

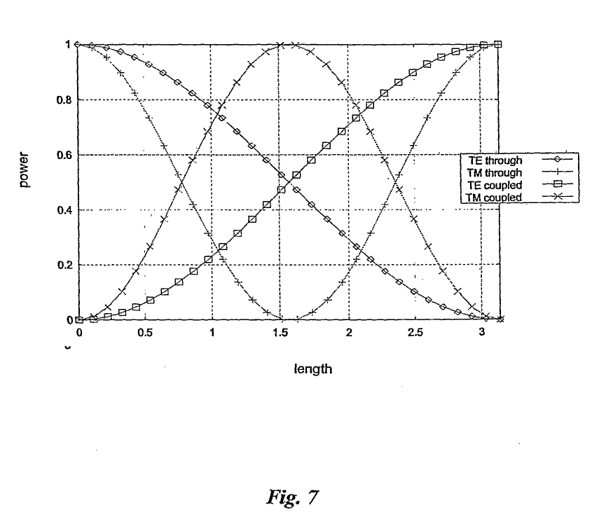

A diagram illustrating properties of the polarisation splitter is shown in FIG. 7. FIG. 7 shows power versus coupling length plots for such a polarisation coupler. It will be appreciated, however, that a range of materials other than LiNbO₃ may be used for this device.

### Polarisation Diverse 3 dB Splitter

Since it is possible to adjust the relative coupling lengths of the TE and TM modes, it is possible to realise a directional coupler that has

L_{cTE}=3L_{cTM} eq. 19

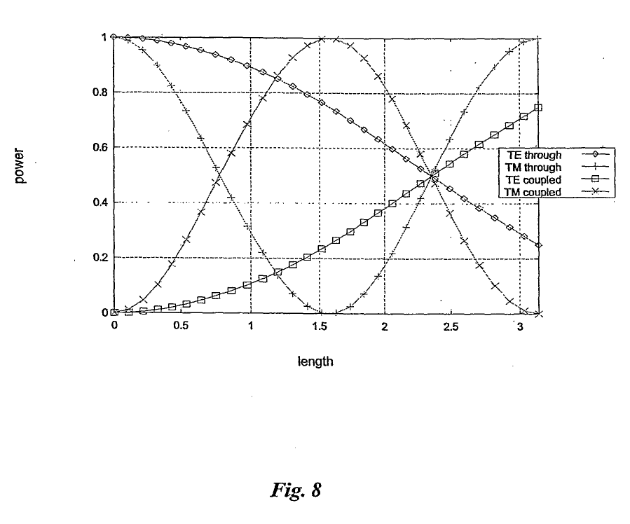

### The coupling characteristics of this structure are shown in FIG. 8. If the coupler length is made to be

L=L_{cTM}/2 eq. 20

Then the result will be a 3 dB coupler for both TE and TM components. FIG. 8 shows power versus coupling length plots for such a polarisation coupler. It is worth noting that the trends for the TE and TM components are reversed at the output.

1. An optical processing device comprising:
an optical light guiding arrangement having an input and an output and at least two arms between the input and the output, the at least two arms being coupled so that light guided through one arm will interfere with light guided through the or each other arm,
an optical modulator being arranged to impart a modulation on at least some of the light guided through at least one arm and
a waveset selective polarisation rotator for wavelength specific rotation of the polarization of at least a portion of the guided light so as to control a modulation gain coefficient of the device.

2. The optical processing device as claimed in claim 1 wherein the polarisation rotator is arranged for at least partial inversion of the polarisation.

3. The optical processing device as claimed in claim 2 wherein the polarisation rotator is arranged to rotate the polarisation by an angle in the range π(2n+1)/2 to π(n+1) (n: integer).

4. The optical processing device as claimed in claim 1 wherein the polarisation rotator is also suitable for rotating the polarisation by an angle in the range of m*π to π(2m+1)/2 (m: integer).

5. The device as claimed in claim 1 wherein the modulator is an optical phase modulator arranged to impart a phase modulation.

6. The device as claimed in claim 1 wherein the modulator is an optical intensity modulator arranged to impart an intensity modulation.

7. The optical processing device as claimed in claim 1 being arranged so that in use the optical processing device has a positive modulation coefficient for at least one wavelength of guided light and a negative modulation coefficient for at least one other wavelength of the guided light.

8. The optical processing device as claimed in claim 1 wherein the modulator and the polarisation rotator are incorporated in respective arms of light guiding arrangement.

9. The optical processing device as claimed in claim 1 comprising at least two modulators and being arranged so that light is guided through the polarisation rotator and respective portions of the light are guided through respective modulators.

10. The optical processing device as claimed in claim 9 comprising two modulators and wherein each modulator is associated with a respective arm of the device.

11. The optical processing device as claimed in claim 9 wherein the polarisation rotator is positioned so that the light passes through the polarisation rotator before being split into the at least two arms of the device.

12. The optical processing device as claimed in claim 11 wherein the optical light guiding arrangement comprises a polarisation splitter that is arranged to split at least some of the guided light into the respective portions for guiding through the respective modulators.

13. The optical processing device as claimed in claim 11 wherein the output comprises, or is connected to, a polarisation combiner.

14. The optical processing device as claimed in claim 9 comprising at least two modulators for modulating respective portions of the light guided through respective arms of the device and at least two polarisation rotators for rotation of the polarisation of respective portions of the light guided through respective arms of the device.

15. The optical processing device as claimed in claim 1 wherein one modulator is associated with both arms of the device.

16. The optical processing device as claimed in claim 1 wherein one polarisation rotator is associated with both arms of the device.

17. The optical processing device as claimed in any claim 1 wherein the polarisation rotator is arranged for rotation of the polarization in a wavelength specific manner.

18. The optical processing device as claimed in claim 1 wherein the polarisation rotator is an acoustic-optic polarisation rotator.

19. The optical processing device as claimed in claim 1 wherein the polarisation rotator is an electro-optic polarisation rotator.

20. A method of processing a photonic signal, comprising the steps of:
guiding light through at least two arms of an optical light guiding arrangement,
modulating at least some of the guided light,
rotating the polarisation of at least a portion of the guided light to determine a modulation coefficient of the modulation and thereafter
interfering the light guided through the or each arm,
wherein rotating the polarization is performed in a wavelength specific manner.

21. The method as claimed in claim 20 wherein the step of rotating the polarisation is performed so that for at least one wavelength of the guided light a positive modulation is effected and for at least one other wavelength of the guided light a negative modulation coefficient is effected.
